(19) United States
(12) Patent Application Publication
(10) Pub. No.: US 2009/0083468 A1
(43) Pub. Date: Mar. 26, 2009

(54) MANAGEMENT METHOD FOR UNIVERSAL SERIAL BUS (USB), BOOTING METHOD FOR COMPUTER DEVICE AND APPLIED MODULE THEREOF

(75) Inventor: Ming-Jen Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/205,922

(22) Filed: Sep. 8, 2008

(30) Foreign Application Priority Data
Sep. 26, 2007 (TW) 96135677

(51) Int. Cl. G06F 13/00

(52) U.S. Cl. 710/305; 710/316

(57) ABSTRACT

A management method for a USB includes the step of detecting number of electronic devices connected to USB interfaces in a first group, and the USB interfaces in the first group are coupled to a first control terminal. Number of electronic devices connected to USB interfaces in a second group is detected, and the USB interfaces in the second group are coupled to a second control terminal. A third group is provided, and USB interfaces therein are switched to be coupled to the first or second control terminal. Number of electronic devices connected to the USB interfaces in the third group is further detected in the invention. The USB interfaces in the third group are determined to be coupled to the first or second control terminal according the numbers of the electronic devices connected to the first, second, and third groups. The working performance of the USB is improved.

### CROSS-REFERENCE TO RELATED APPLICATION

This application claims the priority benefit of Taiwan application serial no. 96135677, filed on Sep. 26, 2007. The entirety of the above-mentioned patent application is hereby incorporated by reference herein and made a part of specification.

### BACKGROUND OF THE INVENTION

1. Field of the Invention

The invention relates to a management technology for a universal serial bus (USB) and, more particularly, to a management technology for switching working modes of a USB.

2. Description of the Related Art

A universal serial bus (USB) is a serial bus standard of connecting external devices, and it is widely used in computers. A USB interface can be connected with an external device such as a mouse, a keyboard, a game handle, a joystick, a scanner, a digital camera, a printer, a hard disk, a network component, etc. It is well known that the great advantage of the USB is that the USB supports hot-plug and plug&play (PnP). When a device is plugged into a USB interface, a host can load a needed driving program according to the connected device, and therefore, it is more convenient to use the USB than a peripheral component interface (PCI) bus or an industry standard architecture (ISA) bus.

FIG. 1 is a block diagram showing the configuration of a basic USB interface module. As shown in FIG. 1, a USB interface module 100 is designed to be asymmetric, and the USB interface module 100 consists of a control unit 102 and a plurality of USB interfaces (such as 104 and 106). Generally speaking, the control unit 102 can be connected with a maximum of five-level USB interfaces, and it can be connected with a maximum of one hundred and twenty-seven external devices.

Although the control unit 102 can be connected with so many external devices, if too many devices are connected to the control unit 102 simultaneously, the data transmission efficiency is caused to decrease. As shown in FIG. 1, if the USB interfaces 104 and 106 are connected with external devices 112 and 114 during the same time interval, the control unit 102 needs to process data transmission of two paths at the same time, and this causes the processing performance to decrease. However, most of present external devices using USB interfaces require a high data transmission rate, and therefore, the condition that a plurality of USB interfaces connected to the single control unit 102 causes the performance to decrease is further obvious.

### BRIEF SUMMARY OF THE INVENTION

The invention provides a universal serial bus (USB) interface module and a management method thereof, and the USB interface module is allowed to be operated in a preferred working mode according to the condition of each USB interface.

Another objective of the invention is to provide a power on self test method for a computer device, and the working mode of a USB interface module can be automatically switched to enable the USB interface module to have preferred working performance.

The invention provides a USB interface module including a control unit group, an input/output interface and a switching module. The control unit group at least has a first control unit and a second control unit, and the input/output interface at least has a first USB interface, a second USB interface and a third USB interface. The first USB interface is coupled to the first control unit, and the second USB interface is coupled to the second control unit. The switching module is coupled to the input/output interface. In this way, the third USB interface is controlled to be coupled to the first or second control unit according to the working state of each USB interface.

The invention further provides a USB interface module including a control unit group, an input/output interface and a switching module. The control unit group has a plurality of control units, and the input/output interface includes a plurality of USB interface groups that are respectively and correspondingly coupled to the control units. The switching module is coupled to the input/output interface, and it adjusts working modes of the USB interface groups according to the working states of the USB interface groups.

The invention provides a management method for a USB, and the management method is applied to a plurality of USB interfaces. The management method of the invention includes the steps of detecting device connection conditions of the USB interfaces and generating a plurality of detecting values. The working modes of the USB interfaces are adjusted according to the detecting values.

The invention further provides a booting method for a computer device, and the booting method is applied to a computer device having a plurality of USB interfaces. The booting method of the invention includes the steps of loading a basic input/output system (BIOS), detecting device connection conditions of the USB interfaces in the computer device and generating a plurality of detecting values. The working modes of the USB interfaces are adjusted according to the detecting values.

In the invention, a detecting module can detect the device connection condition of each USB interface, and then the working mode of the USB interface is adjusted. Therefore, USB interfaces of the invention can be operated in a preferred mode at any time to raise working performance.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing the configuration of a basic universal serial bus (USB) interface module;

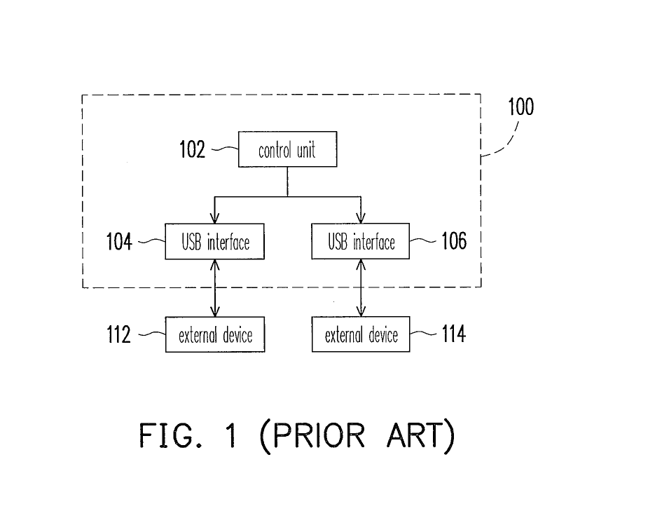

FIG. 2 is a schematic diagram showing the system configuration of a computer device;

FIG. 3 is a block diagram showing the system of a USB interface module according to the first embodiment of the invention;

FIG. 4 is a schematic diagram showing the system configuration of a USB interface module according to the second embodiment of the invention; and

FIG. 5 is flow chart showing steps of a management method for a USB according to a preferred embodiment of the invention.

### DETAILED DESCRIPTION OF THE EMBODIMENTS

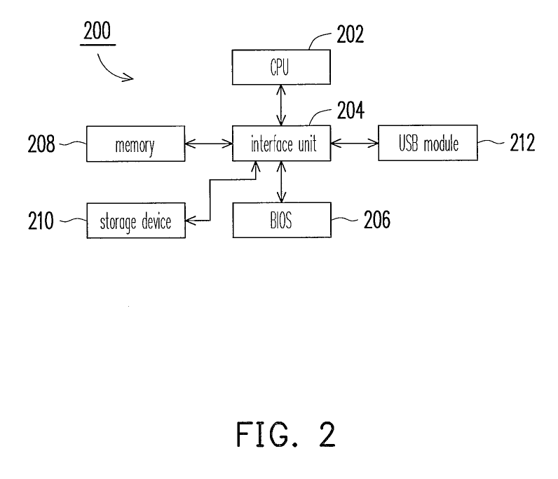

FIG. 2 is a schematic diagram showing the system configuration of a computer device. As shown in FIG. 2, a computer system 200 of a common computer such as a desktop computer or a notebook computer includes a central processing unit (CPU) 202, an interface unit 204, a basic input/output system (BIOS) 206, a memory 208, a storage device 210 and a USB interface module 212. The CPU 202 is coupled to the interface unit 204, and it is coupled to the BIOS 206, the memory 208, the storage device 210 and the USB interface module 212 via the interface unit 204. Generally speaking, the interface unit 204 may include, for example, a north bridge chip and a south bridge chip. The storage device 210 may be a hard disk.

When the computer system 200 is booted, it may execute the power on self test, decompress program codes in the BIOS 206 and loads the decompressed program codes into the memory 208 via the interface unit 204 to execute the program codes. In the embodiment, the memory 208 may be a dynamic random access memory (DRAM), a synchronous dynamic random access memory (SDRAM) or a double data random access memory (DDRAM).

After the computer system 200 finishes the power on self test and programs executed by the BIOS 206, a suitable operating program in the storage device 210 can be loaded into the memory 208 via the interface unit 204 to finish the booting program of the computer system 200. In the booting method provided by the embodiment of the invention, the BIOS 206 can detect the connection condition of the USB interface module 212 via the interface unit 204 to set the working mode of the USB interface module 212 before an operating system is loaded into the computer system 200.

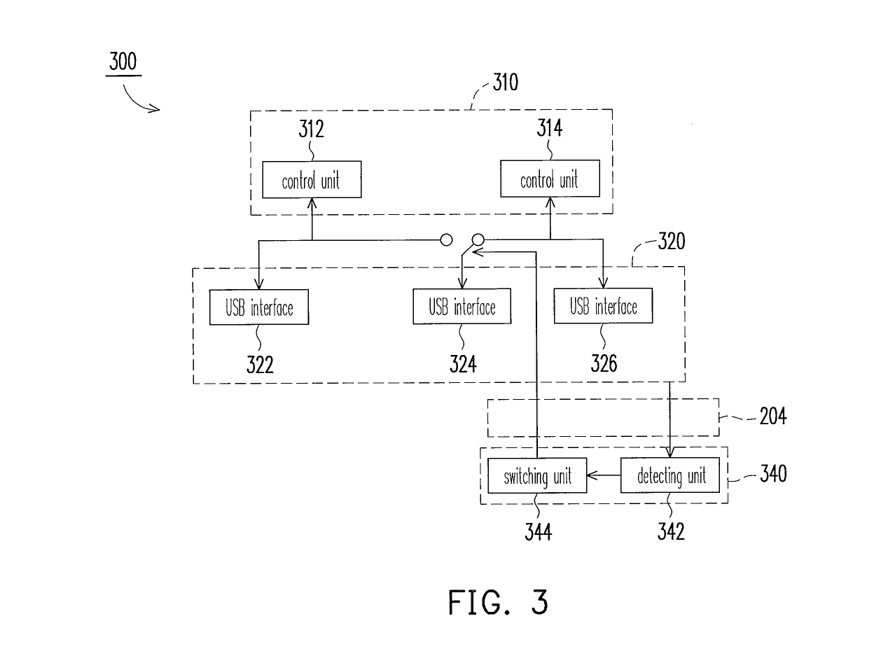

FIG. 3 is a block diagram showing the system of a USB interface module according to the first embodiment of the invention. As shown in FIG. 3, a control unit group 310, an input/output interface 320 and a switching module 340 are provided in the embodiment. The control unit group 310 and the switching module 340 are coupled to the input/output interface 320. In the embodiment, the standard of the USB interface module is a USB 1.1 or 2.0 standard.

The control unit group 310 at least includes control units 312 and 314, and the input/output interface 320 at least includes USB interfaces 322, 324 and 326. In the embodiment, the USB interface 322 is coupled to the control unit 312, and the USB interface 326 is coupled to the control unit 314. In some embodiments, the control unit 314 is provided in the interface unit 204. For example, the control unit 314 may be provided in the south bridge chip in the interface unit 204.

The switching module 340 may include a detecting unit 342 and a switching unit 344. The detecting unit 342 can detect the connection condition of each USB interface and transmit a detecting result to the switching unit 344. In this way, the switching unit 344 can control the USB interface 324 to be coupled to the control unit 312 or 314 according to the detecting result of the detecting unit 342.

If the detecting unit 342 detects that each of the USB interfaces 322 and 324 is connected with an electronic device (such as a network card, a portable flash memory device, etc.), respectively, the detecting unit 342 notifies the switching unit 344 of the detecting result. At this moment, to relieve the loading of the control unit 312, the switching unit 344 can control the USB interface 324 to be coupled to the control unit 314. In this way, the control units 312 and 314 can share tasks with each other. Taking another example to illustrate, if the detecting unit 342 detects that each of the USB interfaces 324 and 326 is connected with an electronic device, respectively, the switching unit 344 can control the USB interface 324 to be coupled to the control unit 312 according to the detecting result of the detecting unit 342.

In some embodiments, the detecting unit 342 and the switching unit 344 may be programmed by a program language. In other alternative embodiments, the switching module 340 may be provided in the BIOS. Therefore, the switching module 340 may be coupled to the input/output interface 320 via the interface unit 204.

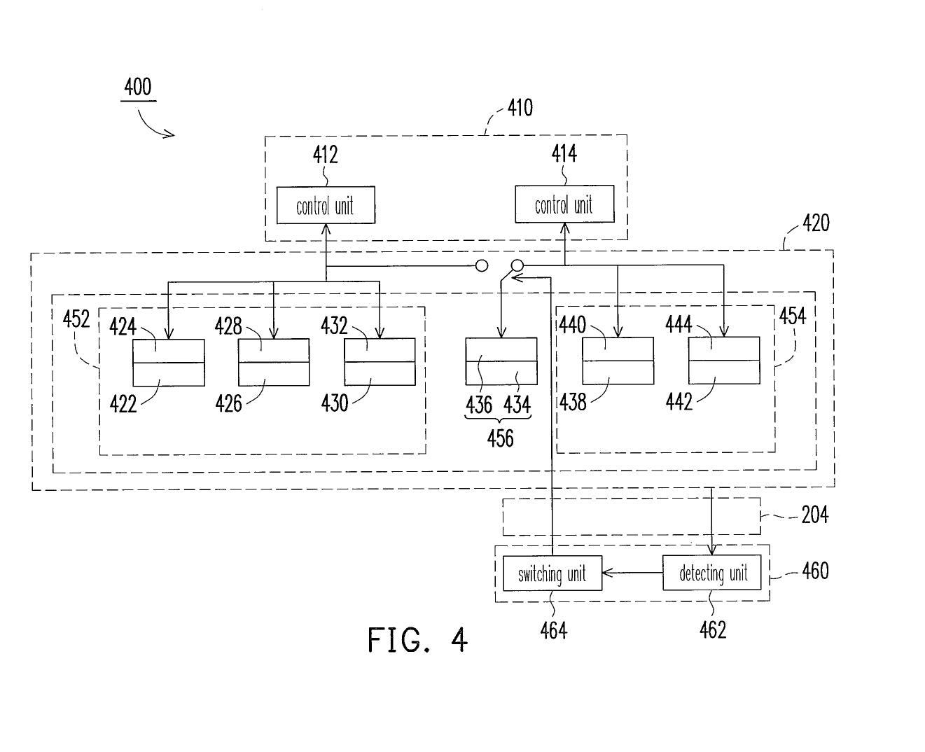

FIG. 4 is a schematic diagram showing the system configuration of a USB interface module according to the second embodiment of the invention. As shown in FIG. 4, a USB interface module 400 provided by the embodiment may also include a control unit group 410, an input/output interface 420 and a switching module 460. The control unit group 410 and the switching module 460 may also be coupled to the input/output interface 420.

The control unit group 410 also at least includes control units 412 and 414. However, the input/output interface 420 includes a plurality of USB interfaces such as 422, 424, 426, 428, 430, 432, 434, 436, 438, 440, 442 and 444. Some of the USB interfaces (such as 422 to 432) may be classified as a first group 452, and some of the USB interfaces (such as 438 to 444) may be classified as a second group 454. The USB interfaces in the first group 452 can be coupled to the control unit 412, and the USB interfaces in the second group 454 can be coupled to the control unit 414.

The other USB interfaces such as 434 and 436 are classified as a third group 456. The USB interfaces in the group 456 are controlled to be coupled to the control unit 412 or 414 by the switching module 460.

The switching module 460 is similar to the switching module of the first embodiment, and it has a detecting unit 462 and a switching unit 464. The detecting unit 462 can detect the number of electronic devices connected to the USB interfaces in the first group 452 and obtain a first detecting value. The detecting unit 462 can also detect numbers of electronic devices connected to the USB interfaces in the second group 454 and the third group 456 and obtain a second detecting value and a third detecting value, respectively. In this way, the switching unit 464 can determine to enable the USB interfaces in the third group 456 to be coupled to the control unit 412 or 414 according to the first detecting value, the second detecting value and the third detecting value.

In the embodiment, it is supposed that the first detecting value is X, the second detecting value is Y, and the third detecting value is Z, wherein X, Y and Z can be positive integers or zero. When the relationship among X, Y and Z satisfies a first judgment formula, the switching unit 464 can maintain the USB interfaces in the group 456 to be coupled to the control unit 414, and the first judgment formula is shown as follows:

|(X+Z)−Y|>|X−(Y+Z)| (1)

For example, when the detecting unit 462 detects that two electronic devices (X=2) are connected to the USB interfaces in the first group 452, no electronic device (Y=0) is connected to the USB interfaces in the second group 454, and one electronic device (Z=1) is connected to the USB interface in the third group 456, the relationship among X, Y and Z satisfies the first judgment formula (3>1). Therefore, the switching unit 464 can control the USB interfaces in the group 456 to be coupled to the control unit 414.

When the relationship among X, Y and Z satisfies a second judgment formula, the switching unit 464 can control the USB interfaces in the group 456 to be switched and coupled to the control unit 412. The second judgment formula is shown as follows:

|(X+Z)−Y|<|X−(Y+Z)| (2)

For example, when the detecting unit 462 detects that no electronic device (X=0) is connected to the USB interfaces in the first group 452, one electronic device (Y=1) is connected to the USB interface in the second group 454, and one electronic device (Z=1) is connected to the USB interface in the third group 456, the relationship among X, Y and Z satisfies the second judgment formula (0<2). Therefore, the switching unit 464 can control the USB interfaces in the third group 456 to be switched and coupled to the control unit 412.

If the relationship among X, Y and Z satisfies a third judgment formula, the switching unit 464 enables the USB interfaces in the third group 456 to maintain their previous condition. For example, the USB interfaces in the third group 456 are still coupled to the control unit 414. The third judgment formula is shown as follows:

|(X+Z)−Y|=|X−(Y+Z) (3)

Similarly, in some embodiments, the switching module 460 may also be programmed by a program language. In other alternative embodiments, the switching module 460 may be provided in the BIOS. Therefore, the switching module 460 may be coupled to the input/output interface 420 via the interface unit 204.

Although the computer system may be a desktop computer or a portable computer, the invention is not limited by this. In fact, the technology provided by the invention can be applied to any computer system having a plurality of USB interface module.

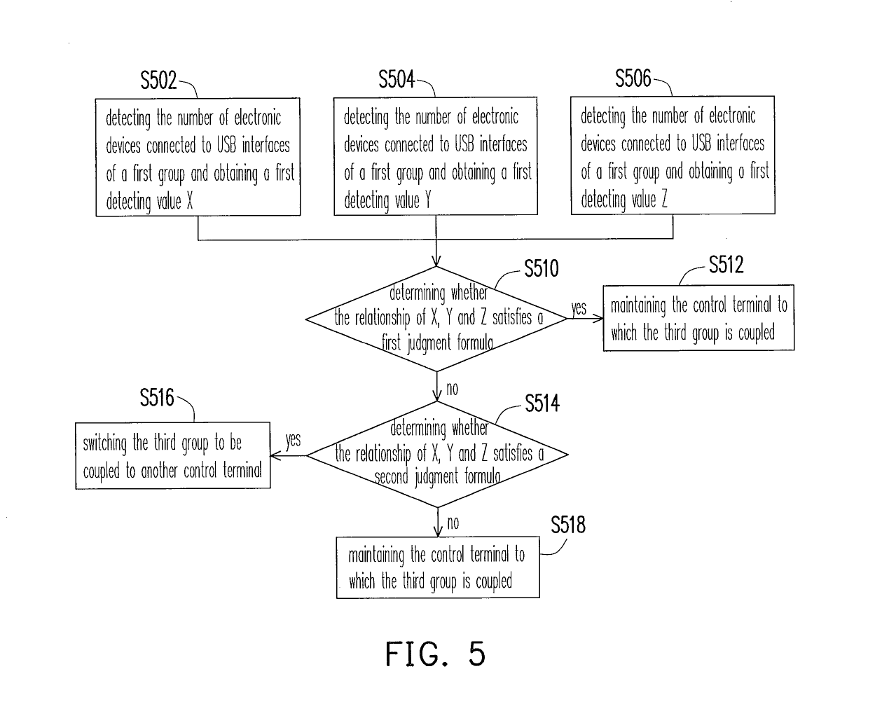

FIG. 5 is flow chart showing steps of a management method for a USB according to a preferred embodiment of the invention. As shown in FIG. 5, based on the above embodiments, the embodiment provides a management method. The management method is applied to a computer system having a plurality of USB interfaces, and it includes the steps of, as shown in the step S502, detecting the number of electronic devices connected to the USB interfaces in a first group (the first group 452 in FIG. 4) and obtaining a first detecting value X. In the step S504, the number of electronic devices connected to the USB interfaces in a second group (the second group 454 in FIG. 4) is detected, and a second detecting value Y is obtained. The number of electronic devices connected to the USB interfaces in a third group (the third group 456 in FIG. 4) is detected and a third detecting value Z is obtained (step S506). In this way, in the embodiment, the USB interfaces in the third group can be selectively coupled to a control terminal (such as the control unit 412 or 414 in FIG. 4) according to the first detecting value, the second detecting value and the third detecting value. In the embodiment, the second group and the third group are supposed to be coupled to the same control terminal that is different from the control terminal to which the first group is coupled.

In the embodiment, the step S510 is executed. That is, whether the relationship among X, Y and Z satisfies a first judgment formula (such as the formula (1)) is determined. If the relationship among X, Y and Z satisfies the first judgment formula (“yes” in the step S510), as shown in the step S512, the USB interfaces in the third group are maintained to be coupled to the control terminal to which they are coupled.

When the relationship among X, Y and Z does not satisfy the first judgment formula (“no” in the step S510), the step S514 is executed. That is, whether the relationship among X, Y and Z satisfies a second judgment formula (such as the formula (2)) is determined. If the relationship among X, Y and Z satisfies the second judgment formula (“yes” in the step S514), the step S516 is executed. That is, the USB interfaces in the third group are switched to be coupled to another control terminal. On the contrary (“no” in the step S514), the step S518 is executed. That is, the USB interfaces in the third group are maintained to be coupled to the control terminal to which they are coupled.

Although three judgment formulas are shown hereinbefore to determine the control unit to which the USB interfaces in the third group are coupled, the invention is not limited by this. Persons having ordinary skill in the art can develop new judgment formulas by themselves, and this does not affect the main spirit of the invention.

To sum up, since in the embodiments of the invention, the working conditions of the USB interfaces can be detected, and the control unit to which some USB interfaces are coupled can be adjusted according to different working conditions, the working performance of the computer device increases.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A universal serial bus (USB) interface module comprising:
a control unit group at least having a first control unit and a second control unit;
an input/output interface at least having a first USB interface, a second USB interface and a third USB interface, wherein the first USB interface is coupled to the first control unit, and the second USB interface is coupled to the second control unit; and
a switching module which is coupled to the input/output interface and is used for controlling the third USB interface to be coupled to one of the first control unit and the second control unit according to working states of the USB interfaces.

2. The USB interface module according to claim 1, wherein the switching module comprises:
a detecting unit which is coupled to the input/output interface and is used for detecting the working states of the USB interfaces; and
a switching unit which is coupled to the detecting unit and is used for enabling the third USB interface to be coupled to one of the first control unit and the second control unit according to the working states of the USB interfaces.

3. The USB interface module according to claim 2, wherein when the detecting unit detects that each of the first USB interface and the third USB interface is correspondingly connected to an electronic device, respectively, the switching unit controls the third USB interface to be coupled to the second control unit.

4. The USB interface module according to claim 2, wherein when the detecting unit detects that each of the second USB interface and the third USB interface is correspondingly connected to an electronic device, respectively, the switching unit controls the third USB interface to be coupled to the first control unit.

5. A universal serial bus (USB) interface module comprising:
a control unit group having a plurality of control units;
an input/output interface comprising a plurality of USB interface groups which are respectively and correspondingly coupled to the control units; and
a switching module which is coupled to the input/output interface and is used for adjusting working modes of the USB interface groups according to working states of the USB interface groups.

6. The USB interface module according to claim 5, wherein the control unit at least has a first control unit and a second control unit.

7. The USB interface module according to claim 6, wherein the input/output interface comprises:
a first USB interface group coupled to the first control unit;
a second USB interface group coupled to the second control unit; and
a third USB interface group selectively coupled to the first control unit or the second control unit.

8. The USB interface module according to claim 7, wherein the switching module comprises:
a detecting unit which is coupled to the input/output interface and is used for detecting the working states of the first USB interface group and the second USB interface group; and
a switching unit which is coupled to the detecting unit and is used for determining to enable the third USB interface group to be coupled to one of the first control unit and the second control unit according to the working states of the first USB interface group and the second USB interface group.

9. The USB interface module according to claim 8, wherein when the detecting unit detects that X electronic devices are coupled to the first USB interface group, Y electronic devices are coupled to the second USB interface group, and Z electronic devices are coupled to the third USB interface group, and values of X, Y and Z satisfy a first judgment formula, the switching unit maintains the third USB interface group to be coupled to the second control unit,
wherein X, Y and Z are positive integers, and the first judgment formula is |(X+Z)−Y|>|X−(Y+Z)|.

10. The USB interface module according to claim 9, wherein when the values of X, Y and Z satisfy a second judgment formula, the switching unit enables the third USB interface group to be switched and coupled to the first control unit, and the second judgment formula is |(X+Z)−Y|−|X−(Y+Z).

11. A management method for a universal serial bus (USB), which is applied to a plurality of USB interfaces, the management method comprising the steps of:
detecting device connection conditions of the USB interfaces and generating a plurality of detecting values; and
adjusting working modes of the USB interfaces according to the detecting values.

12. The management method according to claim 11, wherein the step of detecting the USB interfaces comprises the steps of:
detecting the number of electronic devices connected to a first group of the USB interfaces and generating a first detecting value, wherein the USB interfaces in the first group are coupled to a first control terminal;
detecting the number of electronic devices connected to a second group of the USB interfaces and generating a second detecting value, wherein the USB interfaces in the second group are coupled to a second control terminal; and
detecting the number of electronic devices connected to a third group of the USB interfaces and generating a third detecting value.

13. The management method according to claim 12, wherein when the first detecting value is X, the second detecting value is Y, the third detecting value is Z, and values of X, Y and Z satisfy a first judgment formula, the USB interfaces in the third group are enabled to be coupled to the second control terminal, and the first judgment formula is |(X+Z)−Y|>|X−(Y+Z)|.

14. The management method according to claim 13, wherein when the values of X, Y and Z satisfy a second judgment formula, the USB interfaces in the third group are enabled to be coupled to the first control terminal, and the second judgment formula is |(X+Z)−Y|<|X−(Y+Z)|.

15. A booting method for a computer device, which is applied to a computer device having a plurality of universal serial bus (USB) interfaces, the booting method comprising the steps of:
loading a basic input/output system (BIOS);
detecting device connection conditions of the USB interfaces and generating a plurality of detecting values; and
adjusting working modes of the USB interfaces according to the detecting values.

16. The booting method according to claim 15, wherein the step of detecting the USB interfaces comprises the steps of:
detecting the number of electronic devices connected to a first group of the USB interfaces and generating a first detecting value, wherein the USB interfaces in the first group are coupled to a first control terminal;
detecting the number of electronic devices connected to a second group of the USB interfaces and generating a second detecting value, wherein the USB interfaces in the second group are coupled to a second control terminal; and
detecting the number of electronic devices connected to a third group of the USB interfaces and generating a third detecting value.

17. The booting method according to claim 16, wherein when the first detecting value is X, the second detecting value is Y, the third detecting value is Z, and values of X, Y and Z satisfy a first judgment formula, the USB interfaces in the third group are maintained to be coupled to the second control terminal, and the first judgment formula is |(X+Z)−Y|>|X−(Y+Z)|.

18. The booting method according to claim 17, wherein when the values of X, Y and Z satisfy a second judgment formula, the USB interfaces in the third group are enabled to be coupled to the first control terminal, and the second judgment formula is |(X+Z)−Y|<|X−(Y+Z)|.

19. The booting method according to claim 15 further comprising the step of executing a power on self test.

20. The booting method according to claim 15 further comprising the step of loading an operating system to complete the booting program of the computer device.
